(19) United States
(12) Patent Application Publication
(10) Pub. No.: US 2019/0035517 A1
(43) Pub. Date: Jan. 31, 2019

(54) COAXIAL TRANSMISSION LINE STRUCTURE

(71) Applicant: Raytheon Company, Waltham, MA (US)

(72) Inventors: Angelo M. Puzella, Marlborough, MA (US); Lance A. Auer, Sun Lakes, AZ (US); Norman Armendariz, Plano, TX (US); Donald A. Bozza, Billerica, MA (US); John B. Francis, Littleton, MA (US); Philip M. Henault, Medway, MA (US); Randal W. Oberle, Plano, TX (US); Susan C. Trulli, Lexington, MA (US); Dimitry Zarkh, Waltham, MA (US)

(73) Assignee: Raytheon Company, Waltham, MA (US)

(21) Appl. No.: 15/663,128

(22) Filed: Jul. 28, 2017

(51) Int. Cl. H01B 11/20; H01B 11/18

(52) U.S. Cl. CPC H01B 11/20; H01P 11/005; H01B 11/1808

(57) ABSTRACT

A coaxial transmission line structure having a center conductor section having an input contact and an output contact the output contact being larger than the input contact, the center conductor having a plurality of different geometrically shaped, electrically conductive layers having sizes progressively increasing from the input contact to the larger output contact to conductor transition from the input contact to the larger output contact, the electrically conductive layers being electrically interconnected by staggered microvias passing through dielectric layers to the center, and (B) an outer conductor section disposed about, coaxial with, and electrically isolated from, the center conductor by the dielectric layers.

### TECHNICAL FIELD

This disclosure relates generally to coaxial transmission line structures and more particularly to coaxial transmission line structures having microvias forming an inner and outer conductor for the coaxial transmission line structures.

### BACKGROUND

As is known in the art, microvias are minute holes drilled by a laser to generate the electrical connection between the layers in a multilayer circuit board. The microvia is typically a solid copper filled via with an aspect ratio ≤1:1 where the aspect ratio=microvia height divided by microvia diameter (taken at the top of the microvia hole). A microvia is used to connect RF, power and logic signal transmission lines to fine-pitch, high pin count active MMICs (monolithic microwave integrated circuit), ASICs and plastic quad flat packages. Microvia interconnect technology enables: High density component layout on Printed Wiring Boards (PWBs). Microvias may use a direct solder reflow interconnect to component signal pad (e.g., MMIC and/or passive component); eliminate a “fan-out” pad from a plated through hole (PTH); and reduces parasitic inductance: critical for RF and high speed digital signals.

In many applications it is required to connect electrical outputs of a Microwave Monolithic Integrated Circuit (MMIC) to a larger microwave component. It also sometimes required to supply power and logic signals to such component. A multi-level printed circuit board (PCB) may be required to make these connections between the MMIC and the microwave component using coaxial connectors. The center coaxial connector would have one end connected to the solder ball and the other end connected to a much larger contact pad. For example, the solder ball of the MMIC may have a diameter of 0.006 inches and the contact pad to connect to the microwave component may have a have a diameter of 0.066 inches.

### SUMMARY

In accordance with the present disclosure, a coaxial transmission line structure is provided having: (A) a center conductor section having an input contact and an output contact the output contact being larger than the input contact, the center conductor having a plurality of electrically conductive layers sizes progressively increasing from the input contact to the larger output contact to conductor transition from the input contact to the larger output contact, the electrically conductive layers being electrically interconnected by staggered microvias passing through dielectric layers to the center; and (B) an outer conductor section disposed about, coaxial with, and electrically isolated from, the center conductor by the dielectric layers.

In one embodiment, a coaxial transmission line structure is provided having: a center conductor section with an inner portion of a plurality of electrically conductive layers electrically interconnected by staggered microvias passing through dielectric layers; and an outer conductor section. The outer conductor section is disposed about, coaxial with, and electrically isolated from, the center conductor by the dielectric layers. The outer conductor section a second plurality of staggered micro vias passing through the dielectric layers for electrically interconnecting an outer portion of the electrically conductive layers; the outer portion being dielectrically spaced from the inner portion. The inner portion of one of the electrically conductive layers has a geometric shape different from a geometrical shape of the inner portion of another one of the plurality of electrically conductive layers.

In one embodiment the inner portion of one of the electrically conductive layers has a geometric shape different from a geometrical shape of the inner portion of another one of the plurality of electrically conductive layers.

In one embodiment, a coaxial transmission line structure is provided having: a center conductor section; a stack of vertically positioned dielectric layers; a plurality of electrically conductive layers, each one of the plurality of electrically conductive layers being disposed on a portion of a corresponding one of stack of vertically positioned dielectric layers; and an outer conductor section disposed about, coaxial with, and electrically isolated from, the center conductor section by the stack of vertically positioned dielectric layers. The center conductor section includes: an inner portion of the plurality of electrically conductive layers; and a first plurality of staggered or offset microvias passing through dielectric layers for electrically interconnecting the inner portion of the plurality of electrically conductive layers between and central, input contact and a central, output terminal. The outer conductor section includes: an outer portion of the plurality of electrically conductive layers; and a second plurality of staggered or offset microvias passing through dielectric layers for electrically interconnecting the outer portion of the plurality of electrically conductive layers. The inner portion of one of the plurality of electrically conductive layers has a geometric shape different from a geometrical shape of the inner portion of another one of the plurality of electrically conductive layers.

With such an arrangement, the shapes minimize parasitic inductance and capacitive coupling between the center conductor section and the outer conductor and signal transmission lines.

In one embodiment, the geometrical shape of said one of the first plurality of electrically conducive layers is oval and the geometrical shape of said another one of the first plurality of electrically conductive layers is circular.

In one embodiment, the second plurality of electrically conductive vias is disposed circumferentially around the center conductor section.

In one embodiment, the microvias in the first plurality of microvias passing through one of the stack of vertically positioned dielectric layers are offset from the microvias passing through a lower one of the stack of vertically positioned dielectric layers.

In one embodiment, microvias in the second plurality of microvias passing through one of the stack of vertically positioned dielectric layers are offset from the microvias passing through a lower one of the stack of vertically positioned dielectric layers.

The details of one or more embodiments of the disclosure are set forth in the accompanying drawings and the description below. Other features, objects, and advantages of the disclosure will be apparent from the description and drawings, and from the claims.

### DESCRIPTION OF DRAWINGS

FIG. 1 is a plan view of a coaxial transmission line structure according to the disclosure;

FIGS. 1A-1C are cross sectional views of the coaxial transmission line structure of FIG. 1, such cross sections being taken along lines 1A-1A; 1B-1B, and 1C-1C, respectively in FIG. 1 according to the disclosure;

FIG. 2 is a plan view of a center conductor section of the coaxial transmission line structure of FIG. 1 according to the disclosure;

FIGS. 2A-2C are cross sectional views of the center conductor section of the coaxial transmission line structure of FIG. 2, such cross sections being taken along lines 2A-2A; 2B-2B, and 2C-2C, respectively in FIG. 2 according to the disclosure;

FIG. 2D is an exploded, simplified, perspective view showing the arrangement of conductive layers used in the center conductor section of the coaxial transmission line structure of FIG. 1;

FIGS. 3 and 3A are plan and cross sectional view respectively showing in more detail an outer conductive structure of the coaxial transmission line structure of FIG. 1 according to the disclosure, the cross section of FIG. 3A being taken along line 3A-3A of FIG. 3; and

FIGS. 4 and 4A, 4B are plan and cross sectional view respectively showing in more detail an outer conductive structure of the coaxial transmission line structure of FIG. 1 according to the disclosure, the cross section of FIG. 4A being taken along line 4A-4A of FIG. 3.

Like reference symbols in the various drawings indicate like elements.

### DETAILED DESCRIPTION

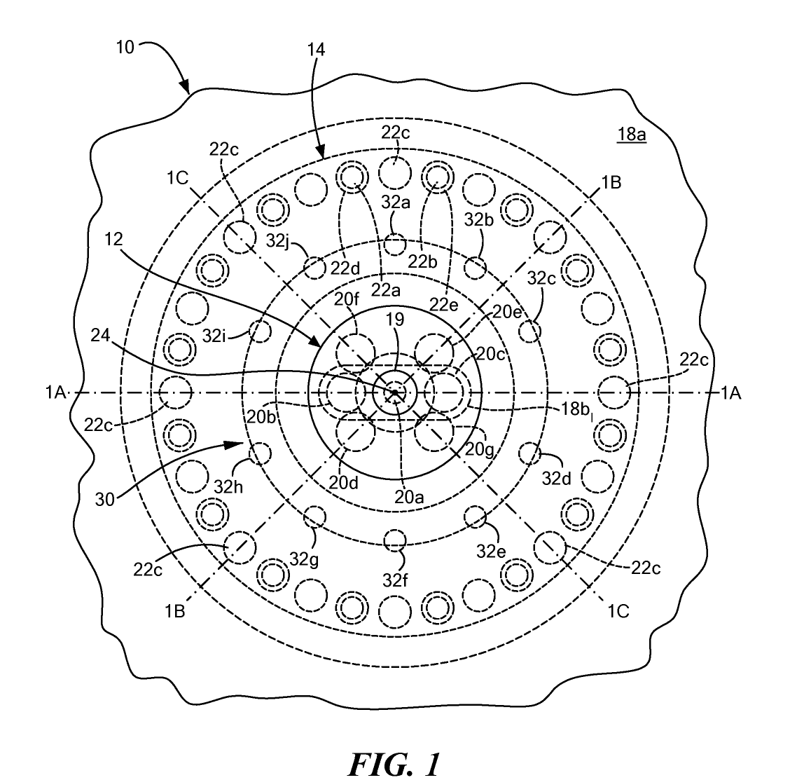

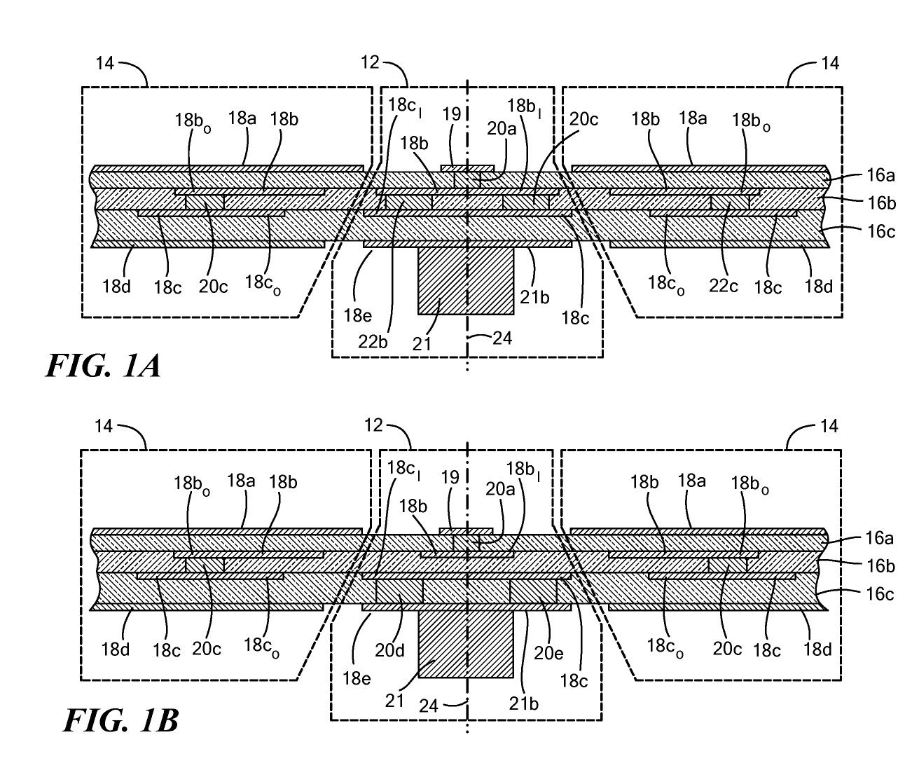

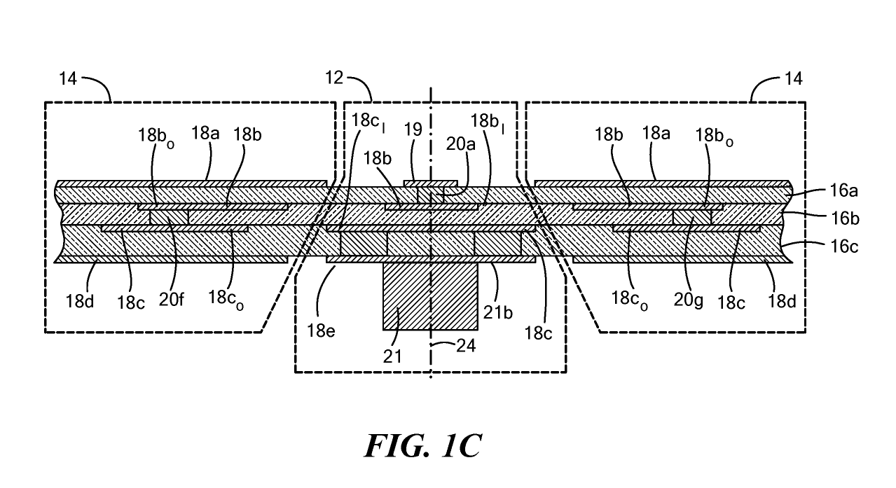

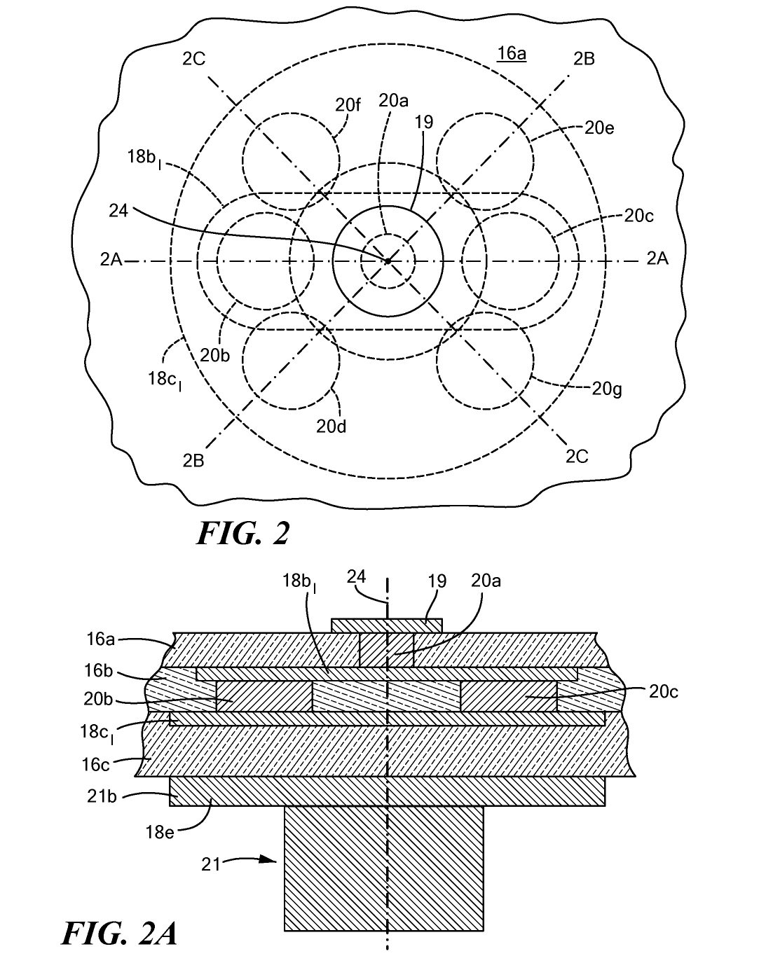

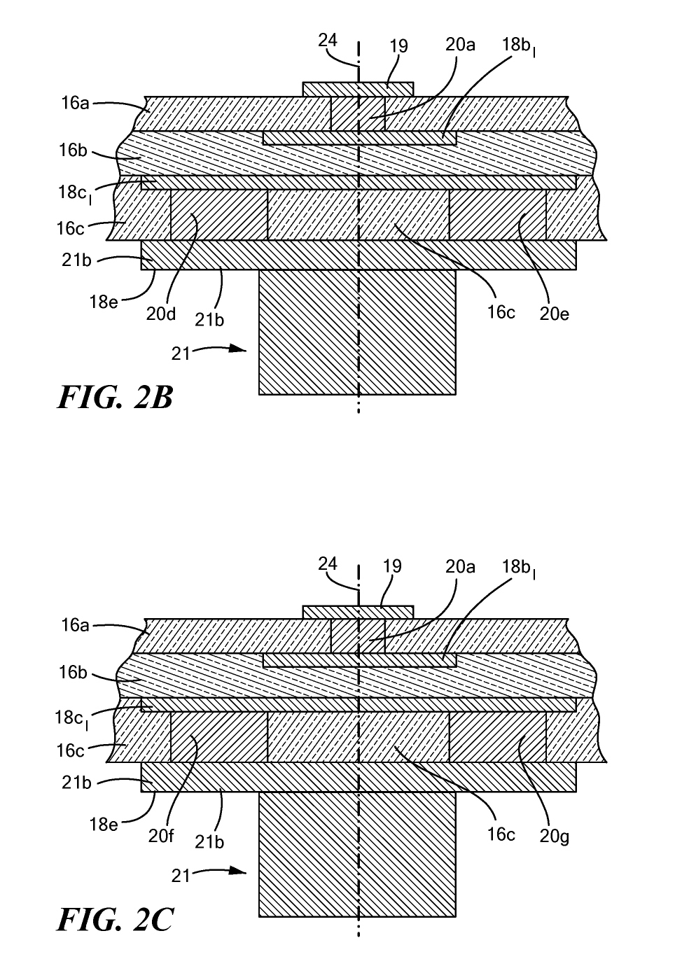

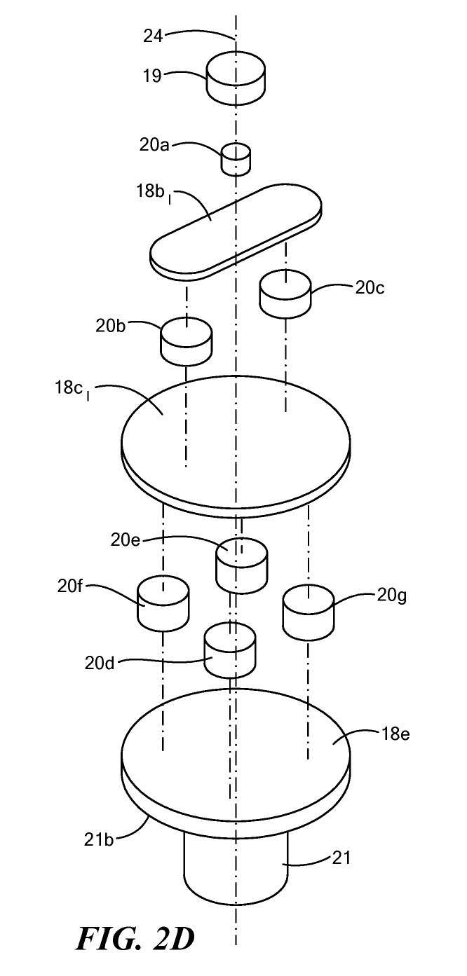

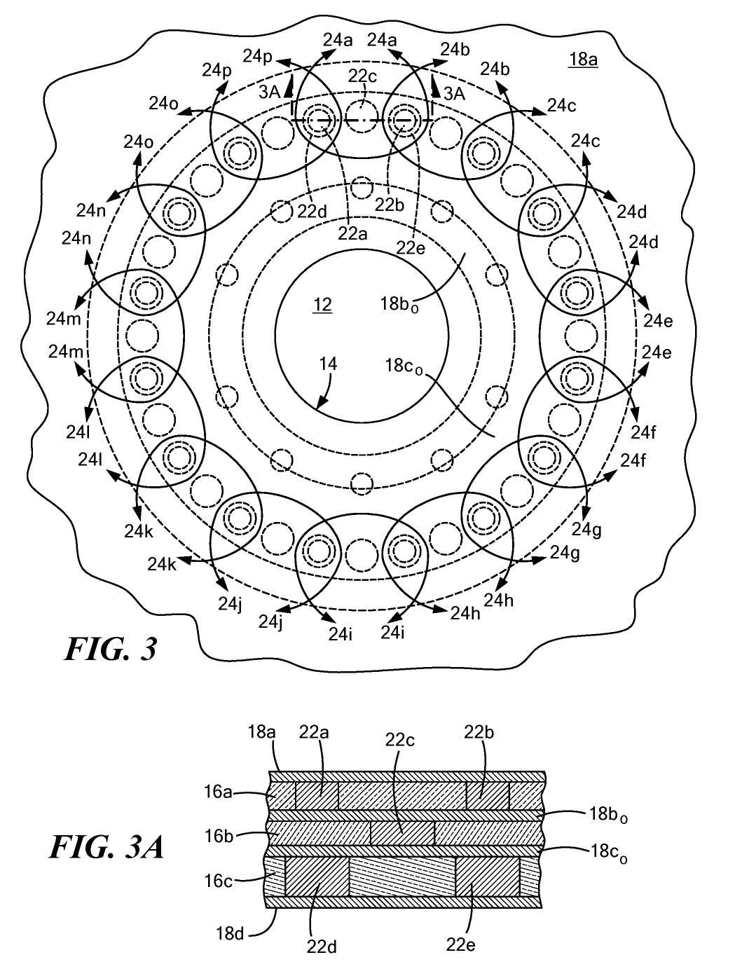

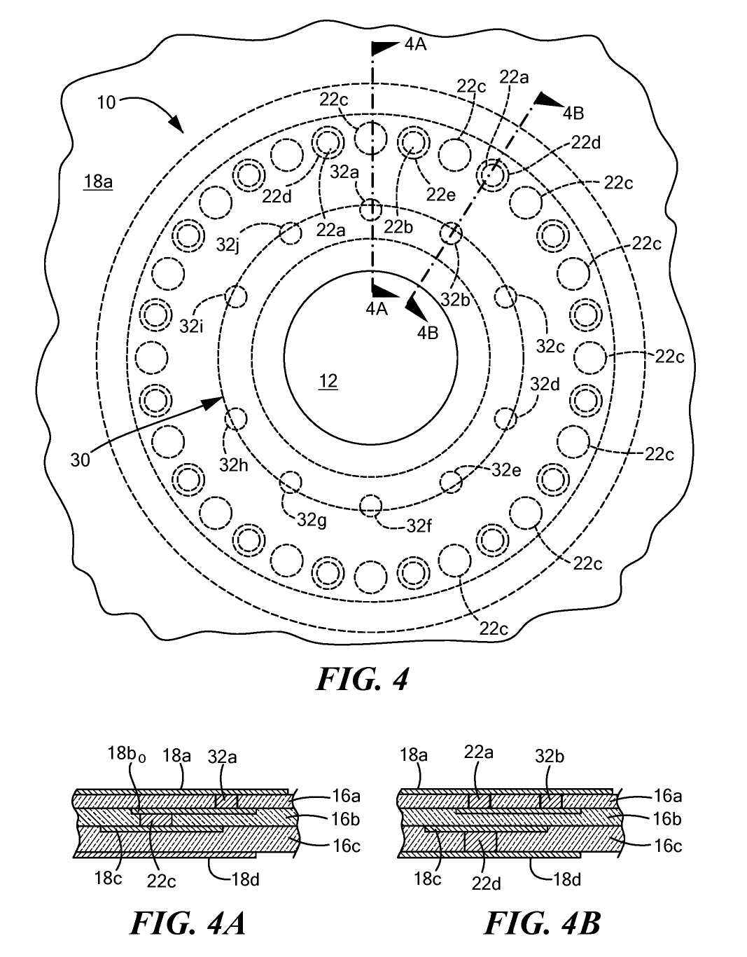

Referring now to FIGS. 1 and 1A-1C, a coaxial transmission line structure 10 is shown having: a center conductor section 12 (shown more clearly in FIGS. 2, and 2A-2D); and an outer conductor section 14 (shown more clearly in FIGS. 3 and 3A), disposed circumferentially about, coaxial with, and electrically isolated from, the center conductor section 12 by a stack of vertically positioned dielectric layers 16a-16c; and an intermediate electrical conductor shielding structure 30, having vias 32a-32j, disposed between the center conductor section 12 and the outer conductor section 14, to be described in more detail in connection with FIGS. 4, 4A and 4B.

More particularly, disposed on a portion of the upper surface of dielectric layer 16a is a central, input contact 19 and an upper conductive, ground plane, layer 18a dielectrically separated from the input contact 19 by the dielectric layer 16a. Disposed within upper surface portions of the dielectric layers 16b and 16c are electrically conductive layers 18b and 18c, respectively, as shown. Disposed on a portion of the bottom of dielectric layer 16c is a lower, conductive ground plane layer 18d and a layer 18e of the base portion 21b of an output contact 21.

It is first noted that input contact 19 which typically may contact a solder ball of an MMIC, not shown, and thus may have a diameter in a range of from 0.006 inches to 0.008 inches, is much smaller than the diameter of the output contact 21 which may typically be in a range of from 0.034 inches to 0.044 inches to contact with a another RF component, such as, for example, a circulator, not shown, mounted to a printed wiring board (PWB), not shown, such PWB having logic signal lines and power lines. Thus, the center conductor section 12 transitions the input contact 19 to the larger output contact 21 by including a plurality of electrically conductive layers 18b_{I} and 18c_{I} having sizes that progressively increase from the input contact 19 to the output contact 21; the electrically conductive layers 18b_{I} and 18c_{I} being electrically interconnected by staggered microvias 20a-20g passing through dielectric layers 16a-16c to electrically interconnect the input contact 19, the plurality of electrically conductive layers 18b_{I}, 18c_{I} and conductive layer 18e of the base portion 21b of output contact 21, as shown.

It is also noted that the inner portion 18b, 18c, of the plurality of electrically conductive layers 18b, 18c, respectively, and layer 18e are part in the center conductor section 12 are dielectrically separated from outer portions 18b_{O}, 18c_{O} of the electrically conductive layers 18b and 18c, respectively. The outer portions 18b_{O}, 18c_{O} of the electrically conductive layers 18b and 18c, layer 18a, and layer 18d are part of the outer conductor section 14. The inner portion 18b_{I}, 18c_{I}, of the plurality of electrically conductive layers 18b, 18c, respectively, and layer 18e are dielectrically separated from the outer portions 18b_{O}, 18c_{O} of the electrically conductive layers 18b and 18c, layer 18a, and layer 18d by intermediate portions of the dielectric layers 16a, 16b and 16c, as shown. As noted above, the input contact 19 disposed on a portion of the upper surface of dielectric layer 16a is dielectrically separated from the electrically conductive layer 18a by portions of dielectric layer 16a and the conductive layer 18e forming a base portion 21b of output contact 21 is disposed on the bottom surface of dielectric layer 16c and is dielectrically separated from the electrically conductive layer 18d by portions of dielectric layers 16c, as shown.

More particularly, and referring to FIGS. 2 and 2A-2D, the center conductor section 12 is shown in more detail. Thus, it is noted that the input contact 19, output contact 21, and the inner portion 18b_{I}, 18c_{I}, of the plurality of electrically conductive layers 18b and 18c, respectively, are electrically interconnected by, as noted above, the plurality of vertically staggered or offset, and horizontally spaced, microvias 20a-20g passing through dielectric layers 16a-16c. Thus, the input contact 19, the plurality of electrically conductive layers 18a-18c and conductive layer 18e of the base portion 21b of output contact 21, are all electrically interconnected, as shown. The spacing between the microvias 20b-20g is a function of the wavelength of the nominal operating wavelength of the coaxial transmission line structure 10; in any event the spacing will be a fraction of the nominal operating wavelength.

Still more particularly, microvia 20a is disposed along a central axis 24 of the coaxial transmission line structure 10, passes through dielectric layer 16a and is used to electrically connect the central, input contact 19 to the inner portion 18b_{I} of conductive layer 18b. Microvias 20b and 20c are disposed along a diameter along line 2A-2A in FIG. 2 equidistant from the central axis 24, as indicated and pass through dielectric layer 16b and are used to electrically interconnect the inner portion 18b_{I} of electrically conductive layer 18b to the conductive layer 18c1. Microvias 20d and 20e are disposed along a diameter 2B-2B in FIG. 2, diameter 2B-2B being at a 45 degree angle to diameter 2A-2A, as shown and being equidistant from the central axis 24, as indicated and pass through dielectric layer 16c and are used to electrically interconnect the inner portions 18c_{I of} electrically conductive layer 18c to the conductive layer 18e forming a base portion 21b of output contact 21. Microvias 20f and 20g are disposed along a diameter 2C-2C in FIG. 2, diameter 2C-2C being at a 90 degree angle to diameter 2B-2B, as shown equidistant from the central axis 24, as indicated and pass through dielectric layer 16c and are used to electrically interconnect the inner portions of the electrically conductive layer of the conductive layer 18e forming a base portion 21b of output contact 21, as shown. It is noted that microvias 20b and 20c are laterally staggered or offset to the left and right of via 20a; microvias 20d and 20e are laterally staggered or offset to the left and right of via 20a; and, microvias 20f and 20e are laterally staggered or offset to the left and right of via 20a. It is further noted that microvias 20d, 20e, 20f and 20g are offset from microvias 20b and 20c.

It is noted that the inner portion 18b_{I} of electrically conductive layer 18b is oval-shaped while the inner portion layer 18c_{I} of electrically conductive layer 18c and the conductive layer 18e are circular shaped. The reason for this difference in shape between the electrically conductive layer 18b and the electrically conductive layers 18c and 18e is that the oval shape of inner portion 18b, for example, minimizes the shunt capacitive coupling between the inner conductor section 12 and the outer conductor structure 14. In addition, the parasitic inductance is reduced on the inner conductor section 12 due to multiple, staggered microvias 20b, c and 20d, 20e, 20f, and 20g that share RF current, reduce current density on the inner conductor section 12 and, thus, reduce the parasitic inductance of the inner conductor section 12. Further, the oval shape provides the mechanical interconnection between the two microvias 20b and 20c

Referring now to FIGS. 3 and 3A, the outer conductor section 14 is shown in more detail to include the electrically conductive layer 18a, the outer portions 18b_{O}, and 18c_{O} of the electrically conductive layers 18b and 18c, respectively, and the conductive layer 18d. Here, for example, the conductive layer 18a and the outer portions 18b_{O} and 18c_{O}, and layer 18d are each toroid or ring-shaped; a thin disk-shaped layer with a hole or aperture passing through the middle of the layer to expose the surface of the dielectric layer supporting the layer. As noted above, the center conductor section 12 is disposed within the aperture passing through the middle of the layer. It is noted that the outer conductor section 14 includes sixteen, identically constructed overlapping regions encircled by arrows 24a-24a through 24p-24p which are disposed coaxial with, and circumferentially about the center conductor section 12, as shown. Referring to an exemplary one of the regions, here for example the region encircled by arrows 24a-24a, as shown in FIG. 3A, each one of the regions includes a plurality of vertically staggered or offset, and horizontally spaced microvias 22a-22e, as shown for an exemplary one of the sixteen regions, as shown in FIG. 3A. The microvias 22a-22e in each one of the sixteen regions pass through the dielectric layers 16a-16c and are disposed between the electrically conductive layer 18a, and the outer portions 18b_{O}, 18c_{O}, and layer 18d as shown across a cord of the outer conductor section 14 in FIG. 3 to electrically interconnect the upper, conductive ground plane layer 18a and the portions 18b_{O}, 18c_{O}, and the lower conductive ground plane layer 18d, as shown.

Referring again to FIGS. 4, 4A and 4B, the coaxial transmission line structure 10 includes an electrically conductive shielding structure 30. The electrically conductive shielding structure 30 includes a plurality of horizontally spaced, identical microvias 32a-32j disposed circumferentially about the center conductor section 12; an exemplary one of the microvias, here microvias 32a and 32b, being shown in FIGS. 4A and 4B to pass through dielectric layer 16a to electrically connect layer 18a with the inner portion 18b_{O} of the electrically conductive layer 18b, as shown.

A number of embodiments of the disclosure have been described. Nevertheless, it will be understood that various modifications may be made without departing from the spirit and scope of the disclosure. For example, or for example, the diameter of, the coaxial transmission line structure 10 may be larger or smaller than that shown in which case the number of microvias will become correspondingly larger or smaller. Likewise the number and/or thicknesses of dielectric layers may be different, depending on the operating wavelength and power handling requirements of the coaxial transmission line structure 10 from that shown. Accordingly, other embodiments are within the scope of the following claims.

1. A coaxial transmission line structure, comprising:
(A) a center conductor section having an input contact and an output contact the output contact being larger than the input contact, the center conductor having a plurality of electrically conductive layers with sizes progressively increasing from the input contact to the output contact, the electrically conductive layers being electrically interconnected by staggered microvias passing through dielectric layers; and
(B) an outer conductor section disposed about, coaxial with, and electrically isolated from, the center conductor section by the dielectric layers.

2. The coaxial transmission line structure recited in claim 1 wherein the plurality of electrically conductive layers have different geometric shapes

3. A coaxial transmission line structure, comprising:
a center conductor section with an inner portion of a first plurality of electrically conductive layers electrically interconnected by staggered microvias passing through dielectric layers; and
an outer conductor section disposed about, coaxial with, and electrically isolated from, the center conductor by the dielectric layers, the outer conductor section comprising:
a second plurality of staggered microvias passing through the dielectric layers for electrically interconnecting an outer portion of the electrically conductive layers; the outer portion being dielectrically spaced from the inner portion; and
wherein the inner portion of one of the electrically conductive layers has a geometric shape different from a geometrical shape of the inner portion of another one of the plurality of electrically conductive layers.

4. A coaxial transmission line structure, comprising:
a center conductor section;
a stack of vertically positioned dielectric layers;
a plurality of electrically conductive layers, each one of the plurality of electrically conductive layers being disposed on a portion of a corresponding one of the stack of vertically positioned dielectric layers;
an outer conductor section disposed about, coaxial with, and electrically isolated from, the center conductor section by the stack of vertically positioned dielectric layers;
wherein the center conductor section comprises:
an inner portion of the plurality of electrically conductive layers;
a first plurality of staggered microvias passing through dielectric layers for electrically interconnecting the inner portion of the plurality of electrically conductive layers between a central input contact and a central output terminal;
wherein the outer conductor section comprises:
an outer portion of the plurality of electrically conductive layers; and
a second plurality of staggered microvias passing through dielectric layers for electrically interconnecting the outer portion of the plurality of electrically conductive layers; and
wherein the inner portion of one of the plurality of electrically conductive layers has a geometric shape different from a geometrical shape of the inner portion of another one of the plurality of electrically conductive layers.

5. The coaxial transmission line structure recited in claim 4 wherein the geometrical shape of said one of the first plurality of electrically conducive layers is oval and the geometrical shape of said another one of the first plurality of electrically conductive layers is circular.

6. The coaxial transmission line structure recited in claim 4 wherein the second plurality of electrically conductive vias is disposed circumferentially around the center conductor section.

7. The coaxial transmission line structure recited in claim 5 wherein microvias in the first plurality of microvias passing through one of the stack of vertically positioned dielectric layers are offset from the microvias passing through a lower one of the stack of vertically positioned dielectric layers.

8. The coaxial transmission line structure recited in claim 4 wherein microvias in the second plurality of microvias passing through one of the stack of vertically positioned dielectric layers are offset from the microvias passing through a lower one of the stack of vertically positioned dielectric layers.

9. The coaxial transmission line structure recited in claim 7 wherein microvias in the second plurality of microvias passing through one of the stack of vertically positioned dielectric layers are offset from the microvias passing through a lower one of the stack of vertically positioned dielectric layers.

10. The coaxial transmission line structure recited in claim 7 wherein the geometrical shape of said one of the first plurality of electrically conducive layers is oval and the geometrical shape of said another one of the first plurality of electrically conductive layers is circular.

11. The coaxial transmission line structure recited in claim 10 wherein the second plurality of microvias is disposed circumferentially around the center conductor section.

12. The coaxial transmission line structure recited in claim 8 wherein the geometrical shape of said one of the first plurality of electrically conducive layers is oval and the geometrical shape of said another one of the first plurality of electrically conductive layers is circular.

13. The coaxial transmission line structure recited in claim 12 wherein the second plurality of microvias is disposed circumferentially around the center conductor section.

14. The coaxial transmission line structure recited in claim 8 wherein the geometrical shape of said one of the first plurality of electrically conducive layers is oval and the geometrical shape of said another one of the first plurality of electrically conductive layers is circular.

15. The coaxial transmission line structure recited in claim 14 wherein the second plurality of microvias is disposed circumferentially around the center conductor section.

16. The coaxial transmission line structure recited in claim 1 including a ground plane conductor having an aperture therein, the aperture being coaxial with, and electrically isolated from, the center conductor section and wherein the outer conductor section comprises a plurality of vertically stacked, electrically connected conductive layers, each one of the conductive layer having an aperture therein, the aperture being coaxial with, and electrically isolated from, the center conductor section and wherein the outer conductor section is electrically connected to the ground plane conductor.

17. The coaxial transmission line structure recited in claim 3 including a ground plane conductor having an aperture therein, the aperture being coaxial with, and electrically isolated from, the center conductor section and wherein the outer conductor section comprises a plurality of vertically stacked, electrically connected conductive layers each one of the conductive layer having an aperture therein, the aperture being coaxial with, and electrically isolated from, the center conductor section and wherein the outer conductor section is electrically connected to the ground plane conductor.

18. The coaxial transmission line structure recited in claim 4 including a ground plane conductor having an aperture therein, the aperture being coaxial with, and electrically isolated from, the center conductor section and wherein the outer conductor section comprises a plurality of vertically stacked, electrically connected conductive layers each one of the conductive layer having an aperture therein, the aperture being coaxial with, and electrically isolated from, the center conductor section and wherein the outer conductor section is electrically connected to the ground plane conductor.

19. The coaxial transmission line structure recited in claim 16 including an intermediate electrical conductor shielding structure disposed between the center conductor section and the outer conductor section, such intermediate electrical conductor shield section comprising a plurality of electrically conducive vias disposed circumferentially abbot the center conductor section, electrically connecting the ground plane conductor to one of the plurality of vertically stacked, electrically connected conductive layers.

20. The coaxial transmission line structure recited in claim 17 including an intermediate electrical conductor shielding structure disposed between the center conductor section and the outer conductor section, such intermediate electrical conductor shield section comprising a plurality of electrically conducive vias disposed circumferentially abbot the center conductor section, electrically connecting the ground plane conductor to one of the plurality of vertically stacked, electrically connected conductive layers.

21. The coaxial transmission line structure recited in claim 18 including an intermediate electrical conductor shielding structure disposed between the center conductor section and the outer conductor section, such intermediate electrical conductor shield section comprising a plurality of electrically conducive vias disposed circumferentially abbot the center conductor section, electrically connecting the ground plane conductor to one of the plurality of vertically stacked, electrically connected conductive layers.
